(19) United States
(12) Patent Application Publication
(10) Pub. No.: US 2024/0265514 A1
(43) Pub. Date: Aug. 8, 2024

(54) COMMERCIAL DISHWASHER AS WELL AS METHOD FOR OPERATING A COMMERCIAL DISHWASHER

(71) Applicant: ILLINOIS TOOL WORKS INC., Glenview, IL (US)

(72) Inventors: Harald DISCH, Elzach (DE); Martin SCHREMPP, Biberach (DE)

(21) Appl. No.: 18/433,037

(22) Filed: Feb. 5, 2024

(30) Foreign Application Priority Data
Feb. 6, 2023 (DE) 10 2023 102 822.7

(51) Int. Cl. G06T 7/00; A47L 15/00; G06V 20/60

(52) U.S. Cl. CPC G06T 7/0002; A47L 15/0005; A47L 15/0007; A47L 15/0013; A47L 15/0026; A47L 15/0028; A47L 15/0034; A47L 15/0076; G06V 20/60; A47L 2401/04; A47L 2501/04; A47L 2501/06; A47L 2501/07; A47L 2501/11; A47L 2501/12; A47L 2501/30; G06T 2207/20081

(57) ABSTRACT

A commercial dishwasher includes at least one washing system for washing washware, having at least one rinsing system for rinsing the washed washware, and optionally a drying system for optimal drying of the rinsed washware. The dishwasher includes a camera system configured to capture at least one image of the washware to be treated in the dishwasher. An evaluation device is further provided, which is configured so as to create a pattern relating to the temporal usage behavior of the operator of the dishwasher, in particular in the course of a profiling process based on the captured images.

### TECHNICAL FIELD

The present invention relates generally to the field of commercial dishwashing, and in particular to a commercial dishwasher, as well as to a method for operating such a commercial dishwasher.

Accordingly, the invention relates to a commercial dishwasher, in particular to a commercial tableware or utensil washer, which is configured as a conveyor dishwasher or as a box-type dishwasher. The commercial dishwasher considered herein comprises at least one washing system for washing washware, at least one rinsing system for rinsing the washed washware, and optionally at least one drying system for optional drying of the rinsed washware.

The dishwasher according to the invention comprises in particular a control device, which is configured so as to “artificially” generate knowledge from experience, in particular according to the principle of machine learning. For this purpose, the dishwasher according to the invention, and in particular the control device of the dishwasher, is configured so as to learn from examples and, upon completion of the learning phase, to generalize the knowledge generated during the learning phase.

In particular, the dishwasher according to the invention is configured, either in the form of a so-called box-type dishwasher or in the form of a conveyor dishwasher, so as to determine, as part of a learning or observation phase, which washware category is predominantly to be treated during which periods of a washing shift or a washing day of the dishwasher. Based on this knowledge, the dishwasher is further configured so as to set, preferably automatically and more preferably selectively automatically, corresponding optimized treatment parameters for treating the washware being washed.

According to realizations of the dishwasher according to the invention, an evaluation device is further provided, which is configured so as to create an overall picture or pattern relating to the temporal usage behavior of the operator of the dishwasher, in particular in the course of a profiling process based on the captured images.

A “profiling process” within the meaning of the present disclosure refers to the usable creation of an overall picture or pattern of the usage behavior of the operator of the dishwasher for specific purposes, and in particular to optimize the operation of the dishwasher, in particular in view of resource consumption (energy, water, and/or chemicals) and/or in view of the cleaning efficiency of the dishwasher and/or in view of a workload relief for the washing personnel. The creation of the overall picture or pattern of the usage behavior of the operator of the dishwasher is preferably carried out by combining data generated during a learning or observation phase, as well as its subsequent analysis and purpose-based evaluation.

In this context, it is thus conceivable that the evaluation device associated with the dishwasher is configured so as to generate a set of statistics and/or a corresponding notification depending on the created overall picture or pattern relating to the temporal usage behavior of the operator of the dishwasher and to output it in particular to the operator of the dishwasher, wherein the notification preferably contains a recommendation for an operation of the dishwasher that is optimized in particular in view of cleaning efficiency and in view of resource savings.

In particular, a control device associated with the dishwasher is configured so as to proactively, and in particular predictively, set controllable components of the dishwasher depending on the created overall picture or pattern relating to the temporal usage behavior of the operator of the dishwasher, so that the dishwasher is operated as optimally as possible in view of resource consumption (energy, water, and/or chemicals) and/or in view of cleaning efficiency of the dishwasher and/or in view of workload relief of the washing personnel.

In terms of general language use, the term “proactively” as used herein means self-determining the development of a cleaning process of the dishwasher and bringing about a situation through differentiated advance planning and targeted action.

The term “predictively” as used herein means indicatively, prognostically, predictably, predictably, and/or in an anticipated fashion.

The dishwasher according to the invention is in particular a commercial tableware or utensil dishwasher, which is configured as a conveyor dishwasher or as a box-type dishwasher. The dishwasher comprises at least one washing system for spraying washing liquid in a washing zone or during a washing phase and at least one rinsing system for spraying rinsing liquid in a rinsing zone or during a rinsing phase. Preferably, the dishwasher according to the present invention further comprises a control device configured so as to suitably control the at least one washing system and/or the at least one rinsing system according to a selected and in particular predetermined schedule.

The invention further relates to a method for operating such a dishwasher. Box-type dishwashers are manually loadable and unloadable dishwashers. Such box-type dishwashers can be tableware rack push-through dishwashers, also called hood-type dishwashers, or front-loaders. Front-loaders can be under-counter machines, countertop machines, or free-standing dishwashers with front loading.

A dishwasher configured as a box-type dishwasher typically comprises a treatment chamber for the cleaning of washware. Typically, a wash tank is arranged below the treatment chamber, in which liquid can flow back from the treatment chamber due to gravity. In the wash tank, there is washing liquid, which is typically water, to which a chemical cleaning agent can be added.

A dishwasher configured as a box-type dishwasher further comprises a washing system having a washing pump, a conduit system connected to the washing pump, and a plurality of spraying nozzles configured in at least one washing arm. The washing liquid located in the wash tank can be conveyed from the washing pump via the conduit system to the spraying nozzles and, through the spraying nozzles, sprayed onto the washware to be cleaned inside the treatment chamber. The sprayed washing liquid subsequently flows back into the wash tank.

Conveyor dishwashers can be designed, in particular, as belt conveyor dishwashers or rack conveyor dishwasher. Conveyor dishwashers are commonly used in the commercial sector. By contrast to box-type dishwashers, in which the washware to be treated or cleaned remains stationary in the dishwasher during the treatment/cleaning, in conveyor dishwashers the washware is conveyed through different treatment zones of the conveyor dishwasher.

A conveyor dishwasher typically comprises at least one pre-washing zone and at least one main washing zone located downstream of the pre-washing zone when viewed in the conveying direction of the washware. When viewed in the conveying direction, at least one post-washing zone and at least one rinsing zone downstream of the post-washing zone are typically arranged downstream of the main washing zone. When viewed in the conveying direction, the washware received either directly on the conveyor belt or held by racks typically run in the conveying direction through the inlet tunnel, the subsequent pre-washing zone, main washing zone, post-washing zone, rinsing zone, drying zone, and into an outlet path.

The washing zones of the conveyor dishwasher are each associated with a washing system comprising a washing pump and a conduit system connected to the washing pump, via which washing liquid is fed to the spraying nozzles of the washing zone. The washing liquid fed to the spraying nozzles is sprayed onto the washware in the respective washing zone, which are conveyed by a conveyor apparatus of the conveyor dishwasher through the respective washing zones. Each washing zone has an associated wash tank in which sprayed liquid is received and/or in which liquid for the spraying nozzles of the respective zone is provided.

In conveyor dishwashers commonly known from the prior art, rinsing liquid in the form of fresh water, which can be pure or can be mixed with further additives such as a rinsing agent, is sprayed via the spraying nozzles of the rinsing zone onto the washware. At least a portion of the sprayed rinsing liquid is conveyed from zone to zone in a cascading system counter to the conveying direction of the wash ware.

The sprayed rinsing liquid is collected in a tank (post-wash tank) of the post-washing zone, from which it is conveyed via the washing pump system of the washing system belonging to the post-washing zone to the spraying nozzles (post-washing nozzles) of the post-washing zone. In the post-washing zone, washing liquid is rinsed off of the washware. The resulting liquid flows into the wash tank of the at least one main washing zone, which is upstream of the post-washing zone when viewed in the conveying direction of the washware. Here, a chemical cleaning agent is typically added to the liquid, and then the liquid is sprayed onto the washware by a pumping system belonging to the washing system of the main washing zone (washing pump) via the nozzles (washing nozzles) of the main washing zone. From the wash tank of the main washing zone, the liquid then flows into the pre-wash tank of the pre-washing zone, unless a further main washing zone is provided. The liquid in the pre-wash tank is sprayed onto the washware by a pumping system belonging to the washing system of the pre-washing zone via the pre-washing nozzles of the pre-washing zone, in order to remove coarse impurities from the washware.

Regardless of whether the dishwasher is configured as a box-type dishwasher or as a conveyor dishwasher, the dishwashers considered herein, and in particular configured for commercial use, thus typically comprise at least one washing system comprising a washing pump that ensures a quasi-constant water circulation over the duration of a washing process in the treatment chamber (for box-type dishwashers) or in the corresponding treatment zone (for conveyor dishwashers). The respective washing pumps of the washing systems are switched on and off by a control device (machine control) belonging to the dishwasher according to a selected and in particular predetermined schedule.

The control device further serves to set additional process parameters of the washing process defined in the selected schedule by controlling suitable components of the dishwasher. This includes, for example, the temperature of the washing liquid sprayed during the washing process, the nozzle pressure at which the washing liquid is sprayed onto the washware during the washing process, if applicable the amount of washing liquid sprayed per unit of time during the washing process, and the washware contact time, i.e. the duration during which the washware is exposed to washing liquid.

In addition, at least one rinsing system is provided for the dishwashers considered herein for spraying rinsing liquid in box-type dishwashers during a rinsing phase in the treatment chamber or in conveyor dishwashers during the treatment in a rinsing zone. The process parameters to be maintained during the rinsing process are also defined in a selected and predetermined schedule and are adjusted by the control device during the rinsing process by means of appropriate controlling of applicably controllable components of the dishwasher. These process parameters include, for example, the temperature of the rinsing liquid sprayed during the rinsing process, the nozzle pressure at which the rinsing liquid is sprayed onto the washware during the rinsing process, if necessary the amount of rinsing liquid sprayed per unit of time during the rinsing process, and the washware contact time, i.e. the duration during which the washware is exposed to rinsing liquid.

By contrast to conveyor dishwashers, in box-type dishwashers the two main process steps “washing phase” and “rinsing phase” occur in series temporally but not spatially separated in a zone (treatment chamber).

To this end, a dishwasher configured as a box-type dishwasher is typically equipped with two independent liquid systems, preferably completely separated from one another. One of these two liquid systems is a washing liquid circuit, in which, for the purposes of cleaning the washware, a recirculation of the washing liquid from the aforementioned wash tank below the treatment chamber is performed. The other liquid system is a rinsing liquid system, which can typically comprise a water heater for heating fresh water used as the rinsing liquid.

Regardless of the design of the dishwasher as a box-type dishwasher or as a conveyor dishwasher, the main task of rinsing with rinsing liquid can be seen in removing the washing liquid (lye) still located on the washware after the washing phase. Accordingly, fresh water to which a rinsing agent can be added is preferably used as the rinsing liquid.

In the case of box-type dishwashers, the rinsing liquid which flows into the tank arranged below the treatment chamber during the rinsing additionally serves to regenerate the washing liquid received in the tank, because the rinsing liquid sprayed in the treatment chamber during the rinsing phase (pure fresh water or fresh water mixed with the rinsing agent) flows by gravity into the tank arranged below the treatment chamber. Before new washing liquid enters the tank in this way during the rinsing phase in order to regenerate the washing liquid, the same amount of washing liquid is pumped out of the tank in the case of box-type dishwashers.

Dishwashers of the kind considered herein, i.e. commercial dishwashers that are configured as conveyor dishwashers or as box-type dishwashers, typically comprise a control device in which multiple predetermined treatment programs are stored. The treatment programs define different treatment parameters for the individual process steps during washing, rinsing and, if applicable, drying of the washware. The treatment parameters are in particular adapted to the type or category of washware to be treated by the dishwasher.

The provision of different treatment programs is based on the recognition that different types or categories of washware require different treatment parameters for the individual process steps (i.e. washing, rinsing, and, if applicable, drying) based on their application, their degree of soiling, their shape, and/or due to the material.

However, a disadvantage of today's dishwashers can be seen in that there is usually no automatic differentiation of the types of washware to be treated, so that the conventional treatment programs are often designed as a compromise in order to be usable for multiple different types or categories of washware.

In conventional dishwashers of the type considered herein, the individual programs differ primarily in the duration (cycle duration) of the treatment phases or, in the case of special programs, in particular for the treatment of drinking glasses, in the temperature parameters of the washing phase and the rinsing phase.

In dishwashers known from the prior art, operators typically have the option to choose a shorter program, for example for lightly soiled washware, such as for drinking glasses, and a longer program for heavy or more heavily soiled washware.

In practice, the possibility of manual program selection is rarely used by the operator and/or due to stress-related situations in the kitchen, so that as a result, regardless of the type or category of washware actually to be washed, a factory-preset program is primarily used for the treatment of the washware.

If a factory-preset program is used for the treatment of the washware, which is usually designed as a compromise so that it is more or less efficient for multiple washware categories, then, for example, easily soiled washware, such as drinking glasses, are washed uneconomically long and at higher temperatures than would actually be required. On the other hand, there is a risk that, for example, washware with heavy soiling to be removed, in particular food residues, such as cooking utensils and/or tableware, will not be sufficiently cleaned or treated, so that under certain circumstances multiple treatment passes or additional manual cleanings are necessary.

Based on the aforementioned problem, the present invention thus addresses the problem of further developing a dishwasher of the aforementioned type, i.e. a commercial dishwasher, which is configured as a conveyor dishwasher or as a box-type dishwasher, in such a way that it can be operated as efficiently as possible during a washing shift without the intervention of the washing personnel.

The invention is intended in particular to solve the problem of providing a dishwasher of the type considered herein, i.e. a commercial dishwasher, which is configured as a conveyor dishwasher or as a box-type dishwasher, in which good treatment results can be achieved for all washware categories to be treated by efficient use of the resources (fresh water, chemicals, and energy). The efficient operation of the dishwasher in view of resources is to be possible in particular even without manual intervention by the operators, without negatively impacting the quality of the treatment/cleaning of the washware.

In addition, the task of specifying a corresponding method for operating such an industrial dishwasher is to be solved.

Accordingly, the invention relates in particular to a commercial dishwasher having at least one washing system for washing washware, having at least one rinsing system for rinsing the washed washware, and optionally a drying system for optimal drying of the rinsed washware.

The dishwasher according to invention comprises a camera system, which is configured so as to capture images of the washware to be treated in the dishwasher or of the washware treated in the dishwasher, preferably continuously or at predetermined or determinable times and/or events.

According to the invention, it is provided in particular that the dishwasher comprises an evaluation device, which is configured so as to create an overall picture or pattern relating to the temporal usage behavior of the operator of the dishwasher, in particular in the course of a profiling process based on the captured images.

With the present invention, an entirely new approach, not yet known from the field of industrial washing, is pursued. In particular, the dishwasher according to the invention has a certain amount of “intelligence,” because artificial knowledge is generated from experience with the aid of the evaluation device.

The dishwasher and in particular the evaluation device learns from examples during the learning or observation phase, and can generalize them after the learning phase has been completed. To this end, algorithms of the evaluation device in machine learning build a statistical model that is based on training data that was generated in particular during the learning or observation phase. These training data are preferably continuously tested against new data (test data) after the end of the learning or observation phase.

In other words, according to embodiments of the present invention, the evaluation device of the dishwasher does not simply memorize the examples gained during the learning or observation phase, but preferably recognizes patterns and regularities in the learning data.

After a certain learning procedure during the learning or observation phase, this allows the dishwasher according to the invention to be optimally adapted or adaptable to the respective application or to the respective usage behavior of the user. In particular, the evaluation device or a corresponding control device of the dishwasher is designed so as to preferably continuously analyze the washing/rinsing behavior of the washing personnel or the operator of the dishwasher assigned to the dishwasher in order to either automatically adjust process parameters of the dishwasher in response, or to provide recommendations to the washing personnel or the operator of the dishwasher for the most efficient operation of the dishwasher.

The dishwasher according to the invention is thus configured so as to use the images captured with the camera system in order to create an overall picture or pattern relating to the temporal usage behavior of the operator of the dishwasher. In this context, it lends itself for the evaluation device of the dishwasher to further be configured so as to generate a set of statistics and/or a corresponding notification depending on the created overall picture or pattern relating to the temporal usage behavior of the operator of the dishwasher and to output it in particular to the operator of the dishwasher, wherein the notification preferably contains a recommendation for an operation of the dishwasher that is optimized in particular in view of cleaning efficiency and in view of resource savings.

According to embodiments of the dishwasher according to the invention, it is thus configured so as to capture the temporal usage behavior of the operator of the dishwasher during a learning or observation phase over at least one observation period, which preferably relates to a washing shift of the dishwasher, a washing day of the dishwasher, a washing week of the dishwasher, or a sub-period thereof, and then proactively and in particular predictively, that is to say, in advance, set the treatment parameters of the dishwasher. In particular in this context, it is thus conceivable that the dishwasher further comprises a control device, which is configured so as to proactively and in particular predictively set and/or temporally vary at least one treatment parameter according to which the washware is to be treated during washing, rinsing, and/or optional drying during operation of the dishwasher in a washing shift, in a washing day, or in a washing week, preferably automatically and even more preferably optionally automatically, as a function of the created pattern or overall picture.

For example, it is conceivable that, with the aid of the evaluation device of the dishwasher, it will be “recognized” that at the start of a washing day, only relatively little washware is produced per unit of time. The control device associated with the dishwasher reacts accordingly, namely by, for example in the case of a conveyor dishwasher, reducing the conveying speed of a conveyor apparatus associated with the conveyor dishwasher for this period of time (beginning of a washing day).

As a further example, with the aid of the evaluation device, it is determined during the learning or observation phase that, for example, during lunch time, plates, cutlery, and trays are predominantly accumulated as the washware to be treated. The control device makes use of this “knowledge” and fundamentally proactively and preferably predictively sets the treatment parameters of the dishwasher accordingly for the lunch time in order to achieve an optimal cleaning result on the one hand and an efficient treatment of the washware in view of the consumption of resources on the other hand.

The at least one treatment parameter, which is proactively and in particular predictively set and/or temporally-variable as a function of the overall picture pattern created relating to the temporal usage behavior of the operator of the dishwasher, is selected from the following group:
a temperature of a washing liquid that is sprayed onto the washware for washing the washware;
an amount of washing liquid sprayed onto the washware per unit of time during washing of the washware;
a nozzle pressure of the washing liquid sprayed onto the washware during washing of the washware;
a cleaning agent concentration of the washing liquid sprayed onto the washware during washing of the washware;
a duration of a washing operation;
a temperature of a rinsing liquid that is sprayed onto the washware for rinsing the washware;
an amount of rinsing liquid sprayed onto the washware per unit of time during rinsing of the washware;
a nozzle pressure of the rinsing liquid sprayed onto the washware during rinsing of the washware;
a rinsing aid concentration of the rinsing liquid sprayed onto the washware during rinsing of the washware;
a duration of a rinsing operation;
a temperature of a drying air that is blown onto the washware for optionally drying the washware;
an amount of drying air blown onto the washware per unit of time during optional drying of the washware;
a pressure at which drying air is blown onto the washware during optional drying of the washware; and/or
a duration of an optional drying operation.

According to realizations of the dishwasher according to the invention, it is provided that, for creating the overall picture relating to the temporal usage behavior of the operator of the dishwasher, the evaluation device of the dishwasher is configured so as to determine a temporal development of an in particular average degree of loading of the dishwasher with washware, in particular during a learning or observation phase over at least one observation period and preferably over multiple observation periods, each preferably relating to a washing shift of the dishwasher, a washing day of the dishwasher, a washing week of the dishwasher, or a portion thereof, a temporal development of a degree of loading of the dishwasher with washware.

Alternatively or additionally, it is conceivable that the evaluation device is configured so as to determine a temporal development of an in particular average degree of loading of the dishwasher with the washware having at least one predetermined or determinable washware category.

It is further conceivable, alternatively or additionally, that the evaluation device is configured so as to determine a temporal development of an in particular average degree of soiling of the washware to be treated in the dishwasher.

As a further alternative, it is conceivable that the evaluation device is configured so as to determine a temporal development of an in particular average type of soiling of the washware to be treated in the dishwasher.

Preferably, the evaluation device is further configured so as to derive a pattern or a regularity based on the determined temporal development of the in particular average degree of loading of the dishwasher with washware, based on the temporal development of the in particular average degree of loading of the dishwasher with washware having the at least one predetermined or determinable washware category, based on the determined temporal development of the in particular average degree of soiling of the washware to be treated in the dishwasher, and/or based on the determined temporal development of the in particular average type of soiling of the washware to be treated in the dishwasher.

The pattern or regularity then serves to proactively and particularly predictively adjust optimal treatment parameters with the aid of the control device associated with the dishwasher.

According to design variants, the evaluation device of the dishwasher according to the invention is configured so as to evaluate the images captured by the camera system and determine whether at least one of the following washware categories was present at the time of the corresponding image capture:
cutlery or pieces of cutlery;
pots, pans, or GN containers;
glasses, in particular drinking glasses;
trays or tray-like objects;
plates, cups, or bowls;
utensils;
other washware;
mixed washware; and/or
plastic washware.

In this context, it is conceivable in particular that the evaluation device is configured so as to determine, in particular during the learning or observation phase over the at least one observation period, a temporal development of a preferably average degree of soiling of the washware existing in the image capture region of the camera system at the time of the corresponding image capture and/or a temporal development of a preferably average type of soiling of the washware existing in the image capture region of the camera system at the time of the corresponding image capture, wherein the dishwasher comprises a control device, which is configured so as to, proactively and in particular predictively, preferably automatically and even more preferably optionally automatically as a function of the determined temporal development of the in particular average degree of soiling of the washware and/or as a function of the determined temporal development of the in particular average type soiling of the washware, initiate at least one measure influencing the quality of a washing liquid to be sprayed by the washing system and/or proactively and in particular predictively at least one measure influencing the cleaning power of the dishwasher.

In this context, it lends itself for the control device to be configured so as to proactively and in particular predictively set a volumetric flow rate and/or a nozzle pressure and/or a temperature of the washing liquid to be sprayed by the washing system for setting or adjusting the cleaning performance of the dishwasher as a function of the determined temporal development of the in particular average degree of soiling of the washware and/or as a function of the determined temporal development of the in particular average type of soiling of the washware.

Alternatively or additionally, it is conceivable that the control device is configured so as to proactively and in particular predictively set a cleaning agent concentration of the washing liquid to be sprayed by the washing system for setting or adjusting the cleaning performance of the dishwasher as a function of the determined temporal development of the in particular average degree of soiling of the washware and/or as a function of the determined temporal development of the in particular average type of soiling of the washware.

Alternatively or additionally, it is conceivable that the control device is configured so as to proactively and in particular predictively set a duration of a washing operation and/or a duration of a rinsing operation for setting or adjusting the cleaning performance of the dishwasher as a function of the determined temporal development of the in particular average degree of soiling of the washware and/or as a function of the determined temporal development of the in particular average type of soiling of the washware.

Alternatively or additionally, it is conceivable that the control device is configured so as to proactively and in particular predictively set a quantity of fresh rinse water introduced by the rinsing system for setting or adjusting the cleaning performance of the dishwasher as a function of the determined temporal development of the in particular average degree of soiling of the washware and/or as a function of the determined temporal development of the in particular average type of soiling of the washware.

Alternatively or additionally, it is conceivable that the control device is configured so as to proactively and in particular predictively set a separate wash tank regeneration quantity for setting or adjusting the cleaning performance of the dishwasher as a function of the determined temporal development of the in particular average degree of soiling of the washware and/or as a function of the determined temporal development of the in particular average type of soiling of the washware.

Alternatively or additionally, it is conceivable that the control device is configured so as to proactively and in particular predictively set and/or activate a separate and in particular additional machine devices, in particular a cleaning agent direct spraying system, for setting or adjusting the cleaning performance of the dishwasher as a function of the determined temporal development of the in particular average degree of soiling of the washware and/or as a function of the determined temporal development of the in particular average degree of soiling of the washware.

Alternatively or additionally, it is conceivable that the control device is configured so as to proactively and in particular predictively activate an additional pre-clearing or washing module for treating in particular strongly soiled washware for setting or adjusting the cleaning performance of the dishwasher as a function of the determined temporal development of the in particular average degree of soiling of the washware and/or as a function of the determined temporal development of the in particular average degree of soiling of the washware.

According to realizations of the dishwasher according to the invention, the control device is configured so as to proactively and in particular predictively regenerate the washing liquid to be sprayed by the at least one washing system, preferably automatically and more preferably optionally automatically as a function of the determined temporal development of the in particular average degree of soiling of the washware and/or as a function of a determined temporal development of the in particular average type of soiling of the washware, namely by setting, proactively and in particular predictively, in particular in a controlling manner, a regeneration water quantity to be added per unit of time to the washing liquid to be sprayed per unit of time, preferably as a function of a determined temporal development of the in particular average degree of soiling of the washware and/or as a function of the determined temporal development of the in particular average type of soiling of the washware.

Alternatively or additionally, according to realizations of the dishwasher according to the invention, the control device is configured so as to proactively and in particular predictively set the soil-carrying capacity of the washing liquid to be sprayed by the at least one washing system, or to at least adjust it to the determined temporal development of the in particular average degree of soiling and/or the determined temporal development of the in particular average type of soiling of the washware, preferably automatically and more preferably optionally automatically as a function of the determined temporal development of the in particular average degree of soiling of the washware and/or as a function of the determined temporal development of the in particular average type of soiling of the washware.

Advantageously, the control device is configured so as to proactively and in particular predictively set, in particular in a controlling manner, a temperature of the washing liquid and/or cleaning agent concentration of the washing liquid for setting or adjusting the soil-carrying capacity of the washing liquid to be sprayed by the at least one washing system.

According to design variants of the dishwasher according to the invention, the control device is further configured so as to divide the treatment period, which preferably relates to a washing shift, a washing day, or a washing week of the dishwasher, or a period thereof, into a first sub-period and into at least one further second sub-period, wherein:
in the first sub-period of the observation period, a determined in particular average degree of loading of the dishwasher with washware corresponds to a first relative value or falls within a first relative value range, wherein, in the at least one second sub-period of the observation period, the determined in particular average degree of loading of the dishwasher with washware corresponds to a second relative value or falls within a second relative value range, wherein the first relative value of the in particular average degree of loading of the dishwasher with washware corresponds to a loading of the dishwasher with washware which is preferably larger than the loading of the dishwasher with washware corresponding to the second relative value of the in particular average degree of loading of the dishwasher with washware; and/or
in the first sub-period of the observation period, a determined in particular average degree of loading of the dishwasher with at least one predetermined or determinable washware category corresponds to a first relative value or falls within a first relative value range, wherein, in the at least one second sub-period of the observation period, the determined in particular average degree of loading of the dishwasher with at least one predetermined or determinable washware category corresponds to a second relative value or falls within a second relative value range, wherein the first relative value of the in particular average degree of loading of the dishwasher with the at least one washware category corresponds to a loading of the dishwasher with the at least one washware category which is preferably larger than the loading of the dishwasher with the at least one washware category corresponding to the second relative value of the in particular average degree of loading of the dishwasher with the at least one washware category; and/or
in the first sub-period of the observation period, a determined in particular average degree of soiling of the washware to be treated in the dishwasher corresponds to a first relative value or falls within a first relative value range, wherein, in the at least one second sub-period of the observation period, the determined in particular average degree of soiling of the washware to be treated in the dishwasher corresponds to a second relative value or falls within a second relative value range, wherein the first relative value of the in particular average degree of soiling of the washware corresponds to a soil input into the dishwasher (1) which is preferably larger than the soil input into the dishwasher corresponding to the second relative value of the in particular average degree of soiling of the washware;
and/or
in the first sub-period of the observation period, a determined in particular average type of soiling of the washware to be treated in the dishwasher corresponds to a first relative value or falls within a first relative value range, wherein, in the at least one second sub-period of the observation period, the determined in particular average type of soiling of the washware to be treated in the dishwasher corresponds to a second relative value or falls within a second relative value range, wherein the first relative value of the in particular average type of soiling of the washware corresponds to a type of soiling of the washware which is different than the type of soiling of the washware corresponding to the second relative value of the in particular average type of soiling of the washware.

In this context, in particular, it lends itself for the control device to be further configured so as to proactively select and preferably predictively set accordingly, in particular after the end of the learning or observation phase, preferably automatically and more preferably optionally automatically during the operation of the dishwasher in a washing shift, in a washing day, or in a washing week for the first sub-period, at least one first in particular predefined treatment parameter, according to which the washware is to be treated during washing, rinsing, and/or optional drying during the first sub-period, and for the at least one second sub-period, to proactively select and preferably predictively set accordingly at least one second in particular predefined treatment parameter, according to which the washware is to be treated during washing, rinsing, and/or optional drying during the at least second sub-period.

Alternatively or additionally, the first sub-period can be at least a first window of a washing day, a washing shift, or a washing week of the dishwasher, wherein the second sub-period can be at least a different window from the first window of a washing day, a washing shift, or a washing week of the dishwasher.

Alternatively, the first sub-period can be at least a first day of the week, and wherein the second sub-period can be at least a second day of the week that is different from the first day of the week.

According to design variants of the dishwasher according to the invention, the evaluation device is configured so as to determine an operator-specific usage of the dishwasher, in particular over a predetermined or determinable period of time, in particular corresponding to a learning or observation phase, and wherein the evaluation device is further configured so as to do the following, based on the determined operator-specific usage of the dishwasher, in particular over the predetermined or determinable period of time:
determine at least one first period of time during at least one washing day, washing shift, or washing week of the dishwasher, in which only a relatively small number of washware pieces are to be treated by the dishwasher per unit of time, and at least one second period of time during at least one washing day, washing shift, or washing week of the dishwasher, in which a relatively high number of washware pieces are to be washed by the dishwasher per unit of time, and, for these time periods, to proactively and in particular predictively, preferably automatically and more preferably optionally automatically, set treatment parameters adapted to the number of washware pieces to be treated per unit of time; and/or
determine time periods during at least one washing day, washing shift, or washing week of the dishwasher, in which at least one specific washware category is to be treated by the dishwasher at least predominantly, and, for these time periods, to proactively and in particular predictively, preferably automatically and more preferably optionally automatically, set treatment parameters adapted to the at least one determined washware category; and/or
determine time periods during at least one washing day, washing shift, or washing week of the dishwasher, in which at least predominantly strongly soiled washware is to be treated by the dishwasher, and, for these time periods, to proactively and in particular predictively, preferably automatically and more preferably optionally automatically, set treatment parameters adapted to the degree of soiling and/or the type of soiling; and/or
determine time periods during at least one washing day, washing shift, or washing week of the dishwasher, in which at least predominantly lightly soiled washware is to be treated by the dishwasher, and, for these time periods, to proactively and in particular predictively, preferably automatically and more preferably optionally automatically, set treatment parameters adapted to the degree of soiling and/or the type of soiling.

According to a further aspect, the present invention relates in particular to a dishwasher having at least one washing system for washing washware, having at least one rinsing system for rinsing the washed washware, and optionally a drying system for optional drying of the rinsed washware. The dishwasher is in particular a commercial tableware or utensil washer, which is configured as a conveyor dishwasher or as a box-type dishwasher.

The dishwasher according to invention according to this aspect comprises an optical detection system, in particular a camera system, which is configured so as to capture at least one image of the washware to be treated in the dishwasher or of the washware treated in the dishwasher, preferably continuously or at predetermined or determinable times and/or events. Furthermore, an evaluation device is provided, which is designed so as to evaluate and determine based on the at least one image whether washware of certain washware categories was present in the image at the time at which the image was captured.

The washware categories that are identified with the aid of the evaluation device based on the at least one image are in particular at least one of the following washware categories:
cutlery or pieces of cutlery;
pots, pans, or GN containers;
glasses, in particular drinking glasses;
trays or tray-like objects;
plates, cups, or bowls;
utensils, in particular cooking utensils;
other washware;
mixed washware; and/or
plastic washware.

The list of the possible washware categories is in no way to be considered conclusive.

Alternatively or additionally, it is conceivable in particular that the evaluation device is configured so as to determine whether washware of at least one of the following washware categories was present in the image at the time at which the image was captured.
plates made of porcelain or a porcelain-like material;
cups made of porcelain or a porcelain-like material, glass or a glass-like material;
bowls made of porcelain or a porcelain-like material, glass or a glass-like material;
trays or tray-like articles made of a plastic material;
reusable containers or tableware made from a plastic material,
containers, in particular GN containers, made of a metal, in particular stainless steel;
pots made of a metal, in particular stainless steel;
pans made of a metal, in particular stainless steel;
cutlery or pieces of cutlery made of a metal, in particular stainless steel; and/or
drinking glasses made of glass or a glass-like material.

This list of possible washware categories is also by no means to be considered conclusive.

The determination of the washware categories treated or to be treated in the dishwasher is based on the recognition that the process parameters for the washing system, the rinsing system, and/or the optional drying system for an effective treatment or cleaning depend on the type and/or category of the washware to be treated. The different washware categories require suitable treatment programs or parameters according to which the washware are to be treated, for example with the washing system and/or with the rinsing system and/or with the optionally provided drying system.

The treatment programs or parameters are coordinated in particular in view of a volumetric flow of washing liquid to be sprayed by the washing system per unit of time and in view of a nozzle pressure with which the washing liquid is sprayed by the washing system. For example, lightly soiled dishes, such as trays or drinking glasses—as opposed to heavily soiled washware with embedded and difficult-to-remove food residues, such as cooking utensils, chafing dishes, oven tins, etc.—require only a relatively small volumetric flow amount of washing liquid sprayed by the washing system per unit of time and only a relatively low nozzle pressure for spraying of the washing liquid by the washing system.

On the other hand, the different washware categories also require treatment programs that are coordinated to the volumetric flow of rinsing liquid to be sprayed by the rinsing system per unit of time, according to which programs the washware is treated by the rinsing system.

The solution according to the invention is characterized in particular in that the dishwasher further comprises a control device which is designed so as to determine, in particular during a learning or observation phase, over at least one observation period and preferably over a multiple observation periods, which in each case preferably relate to a washing shift or washing day of the dishwasher or a time period thereof, a temporal development of the load of the dishwasher with at least one of the aforementioned washware categories.

In other words, the control device of the dishwasher is configured so as to determine, in particular during the learning or observation phase, when the dishwasher must treat in particular what category or categories of washware within a given washing shift or during a washing day.

Preferably, the control device is further designed so as to derive a pattern or regularity based on the determined temporal development of the load of the dishwasher with the respective washware categories.

Accordingly, the dishwasher according to the invention has a certain “intelligence,” as knowledge is generated artificially from experience with the help of the control device or with the help of the evaluation device. The control device learns from examples during the learning or observation phase, and can generalize them after the learning phase has been completed. To this end, algorithms of the control device in machine learning build a statistical model that is based on training data that is generated in particular during the learning or observation phase. This training data is preferably continuously tested against new data (test data) after the end of the learning or observation phase.

In other words, according to preferred embodiments of the present invention, the control device of the dishwasher according to the invention does not simply memorize the examples gained during the learning or observation phase, but preferably recognizes patterns and regularities in the learning data.

After a certain learning procedure during the learning or observation phase, this allows the dishwasher according to the invention to be optimally adapted or adaptable to the respective application or to the respective usage behavior of the user. In particular, the control device is designed so as to preferably continuously analyze the washing/rinsing behavior of the washing personnel or the operator of the dishwasher assigned to the dishwasher in order to either automatically adjust process parameters of the dishwasher in response, or to provide recommendations to the washing personnel or the operator of the dishwasher for the most efficient operation of the dishwasher.

According to realizations of the dishwasher according to the invention, it is thus provided that the control device is furthermore designed so as to divide the observation period, which preferably relates to a washing shift or washing day or a washing week of the dishwasher or a period of time thereof, into a first sub-period and into at least one further, second sub-period. For example, the first sub-period or the at least one further second sub-period can relate to a specific day of the week of a washing week or a specific period of time of a washing day or shift.

The subdivision of the treatment period, which, as stated, relates to, for example, a washing shift, a washing day, or a washing week of the dishwasher, into the individual sub-periods occurs in particular depending on the washware categories that are to be primarily or predominantly treated by the dishwasher during the sub-periods of the observation period.

For example, in the first sub-period of the observation period, the determined in particular average degree of loading of the dishwasher with at least one of the aforementioned washware categories corresponds to a first relative value, whereas in the at least one second sub-period of the observation period, the determined in particular average degree of loading of the dishwasher with the at least one washware category corresponds to a second relative value.

For example, it is conceivable that the first relative value of the in particular average degree of loading of the dishwasher with the at least one washware category corresponds to a degree of loading of the dishwasher with at least one washware category that is greater than the degree of loading of the dishwasher with the at least one washware category that corresponds to the second relative value of the in particular average degree of loading of the dishwasher with the at least one washware category.

In other words, for example, the first sub-period corresponds to a time period on the morning of a washing day, wherein in the morning, a small amount of very dirty washware to be treated with the dishwasher is usually produced. It is conceivable, for example, that glasses, in particular drinking glasses, are predominantly accumulated for treatment in the morning, but not pots, pans, or GN containers. The second sub-period can, for example, correspond to a time period around midday in which significantly more washware and in particular significantly more washware with strong soilings produced according to experience.

Of course, other windows of time or even days for the first and the at least one other second sub-period are also possible.

Particularly preferably, it is provided that the control device is further configured so as to selected and accordingly set at least one first in particular predetermined treatment parameter according to which the washware is to be treated during the first sub-period during washing, rinsing, and/or optional drying, in particular after the end of the learning or observation phase, preferably automatically and more preferably selectively automatically during operation of the dishwasher in a washing shift, in a washing day, or in a washing week, for the first sub-period.

Likewise, it lends itself for the control device to be further configured so as to select and accordingly set for the at least one second sub-period at least one second, in particular predetermined treatment parameter according to which the washware is to be treated during the at least one second sub-period during washing, rinsing, and/or optional drying.

In other words, in this design variant, the dishwasher according to the invention has a certain amount of intelligence, because the control device associated with the dishwasher “knows” from the previously determined learning data at which periods during a washing day, a washing shift, or a washing week of the dishwasher which type of category of washware is predominately produced. With this knowledge, the dishwasher can automatically adjust the treatment parameters of the dishwasher accordingly without the need for manual intervention by the washing personnel.

For example, the at least one first and/or the at least one second treatment parameter can be at least one of the following treatment parameters:
a temperature of a washing liquid that is sprayed onto the washware for washing the washware;
an amount of washing liquid sprayed onto the washware per unit of time during washing of the washware;
a nozzle pressure of the washing liquid sprayed onto the washware during washing of the washware;
a cleaning agent concentration of the washing liquid sprayed onto the washware during washing of the washware;
a duration of the washing operation;
a temperature of a rinsing liquid that is sprayed onto the washware for rinsing the washware;
an amount of rinsing liquid sprayed onto the washware per unit of time during rinsing of the washware;
a nozzle pressure of the rinsing liquid sprayed onto the washware during rinsing of the washware;
a rinsing aid concentration of the rinsing liquid sprayed onto the washware during rinsing of the washware;
a duration of the rinsing operation;
a temperature of a drying air that is blown onto the washware for optionally drying the washware;
an amount of drying air blown onto the washware per unit of time during optional drying of the washware;
a pressure at which drying air is blown onto the washware during optional drying of the washware; and/or
a duration of an optional drying operation.

For example, it is conceivable that, during a period of time in which only a low loading of the dishwasher with for example pots, pans, or GN containers but a relatively high loading of the dishwasher with trays or tablet-like objects and glasses, in particular drinking glasses occurs or is expected, the control device automatically reduces the temperature of the washing liquid and/or reduces the amount of washing liquid sprayed per unit of time during washing of the washware and/or reduces the nozzle pressure of the washing liquid sprayed onto the washware during washing of the washware and/or reduces the duration of the washing procedure and/or the temperature of the rinsing liquid sprayed onto the washware in order to rinse the washware, and/or increases the duration of the rinsing operation.

Of course, other combinations of the adjustable treatment parameters are also conceivable.

This, with the solution according to the invention, preferably automatically but nevertheless in a simple but effective manner, an “overwashing,” for example, of only lightly soiled washware, for example tablets or drinking glasses, can be prevented, so that during the cleaning process, resources of energy, water, chemicals, etc. are used no longer than is necessary for such only lightly soiled washware.

At already indicated, the first sub-period is at least a first window of a washing day, a washing shift, or a washing week of the dishwasher, wherein the second sub-period is at least a different window from the first window of a washing day, a washing shift, or a washing week of the dishwasher.

Alternatively, however, it is also conceivable that the first sub-period is at least a first day of the week of a washing week of the dishwasher, wherein the second sub-period is at least a second day of the week that is different from the first day of the week of the washing week.

It is thus conceivable in particular for the dishwasher to determine, during the learning or observation phase that, for example, only relatively less heavily soiled washware is accumulated every Friday of a washing week, for example, because the canteen no longer serves lunch. For this time window (washing day Friday), the dishwasher would automatically set different treatment parameters than on the remaining washing days.

The control device is thus preferably configured so as to identify time periods during at least one washing day, during at least one washing shift, or during at least one washing week of the dishwasher in which at least one specific washware category must at least predominately be treated by the dishwasher, based on a user-specific usage of the dishwasher over a predetermined or determinable period of time, which corresponds in particular to the learning or observation phase, and, for these time periods, preferably automatically and even more preferably selectively automatically set treatment parameters which are adapted to the at least one specific washware category.

The learning or observation phase during which the control device determines the temporal development of the loading of the dishwasher with at least one of the washware categories over the at least one observation period, preferably begins at the initial start of operation of the dishwasher. Alternatively or additionally, however, it is conceivable that the learning or observation phase can preferably be manually initiated at any given time.

According to advantageous implementations of the dishwasher, it is provided that the control device is further configured so as to output an error or warning message in particular to the washing personnel assigned to the dishwasher and/or to the operator of the dishwasher, when it is determined by the evaluation device that, at the moment of the image capture, the determined in particular average degree of loading of the dishwasher with the at least one washware category deviates from an in particular average degree of loading of the dishwasher with the at least one washware category determined during the learning or observation phase for this time point, in particular despite consideration of an in particular predetermined or determinable variance.

With this measure, it is thus ensured that, even if the use of the dishwasher deviates from the previously learned user-specific use, a suitable treatment of the washware in view of the category of the washware is implemented.

According to further developments, in particular of the last mentioned design variant, it is provided that the control device is further configured so as to produce statistics about the washware categories to be treated by the dishwasher and/or statistics about the timing of the washware categories to be treated by the dishwasher, in particular during the learning or observation phase.

Preferably, the control device can further be configured so as to generate and/or issue a corresponding notification to the operator of the dishwasher, in particular as a function of the determined temporal development and/or as a function of the generated statistics. Preferably, the notification contains a recommendation for operation of the dishwasher that is, in particular, optimized in view of cleaning efficiency and/or in view of resource savings.

According to implementations of the dishwasher according to the invention, it is embodied as a conveyor dishwasher, wherein the at least one washing system is part of at least one washing zone of the conveyor dishwasher. The at least one rinsing system is part of at least one rinsing zone of the conveyor dishwasher, and the optional drying system is part of at least one drying zone of the conveyor dishwasher.

The conveyor dishwasher further comprises a conveyor apparatus for conveying the washware to be treated and in particular to be cleaned through the at least one washing zone, the at least one rinsing zone, and the optionally provided at least one drying zone. The optical detection system in particular configured as a camera system is configured so as to capture at least one image of a region of the conveyor apparatus, preferably continuously or at predetermined times and/or events.

The invention further relates to a corresponding method for operating a commercial dishwasher for cleaning washware. The dishwasher comprises at least one washing system for washing the washware to be treated, at least one rinsing system for rinsing the washed washware, and optionally at least one drying system for optional drying of the rinsed washware.

The method according to the invention is characterized in particular in that, in particular during a learning or observation phase of a control device associated with the dishwasher, over at least one observation period and preferably over multiple observation periods, which in each case preferably relate to a washing shift, washing day, or a washing week of the dishwasher or a time period thereof, a temporal development of the load of the dishwasher with at least one washware category is determined.

A pattern or regularity is then derived based on the determined temporal development of the different washware categories to be treated by the dishwasher.

In the operating method according to the invention, it is preferably further provided that the observation period is divided into a first sub-period in which at least predominantly a first washware category is to be treated by the dishwasher and at least one further, second sub-period in which at least predominantly one or more washware categories that are different from the first washware categories are to be treated by the dishwasher.

In particular after the end of the learning or observation phase, preferably automatically and more preferably selectively automatically for the first sub-period, at least one adjusted or optimized treatment parameter is set, according to which the washware is to be washed, rinsed, and/or optionally dried.

According to implementations of the operating method according to the invention, it is provided that an error or warning message is in particular output to the washing personnel assigned to the dishwasher and/or to the operator of the dishwasher, when it is determined that a determined in particular average degree of loading of the dishwasher with at least one washware category deviates from an in particular average degree of loading of the dishwasher with the at least one washware category determined during the learning or observation phase for this time point, in particular despite consideration of an in particular predetermined or determinable variance.

Finally, according to one aspect of the operating method according to the invention, it is provided that statistics about the washware categories to be treated by the dishwasher and/or statistics about the timing of the washware category to be treated by the dishwasher are produced, in particular during the learning or observation phase.

Preferably, a corresponding notification can be generated and/or issued to the operator of the dishwasher, in particular as a function of the determined temporal development and/or as a function of the generated statistics. Preferably, the notification contains a recommendation for operation of the dishwasher that is, in particular, optimized in view of cleaning efficiency or in view of resource savings.

### BRIEF DESCRIPTION OF THE DRAWINGS

In the following, the invention will be described in further detail with reference to the accompanying drawings based on exemplary embodiments of the dishwasher according to the invention.

The following are shown:

FIG. 1 a schematic longitudinal sectional view of a dishwasher configured as a conveyor dishwasher according to an exemplary embodiment of the invention; and

FIG. 2 a schematic longitudinal sectional view of a dishwasher configured as a box-type dishwasher according to an exemplary embodiment of the invention.

### DETAILED DESCRIPTION

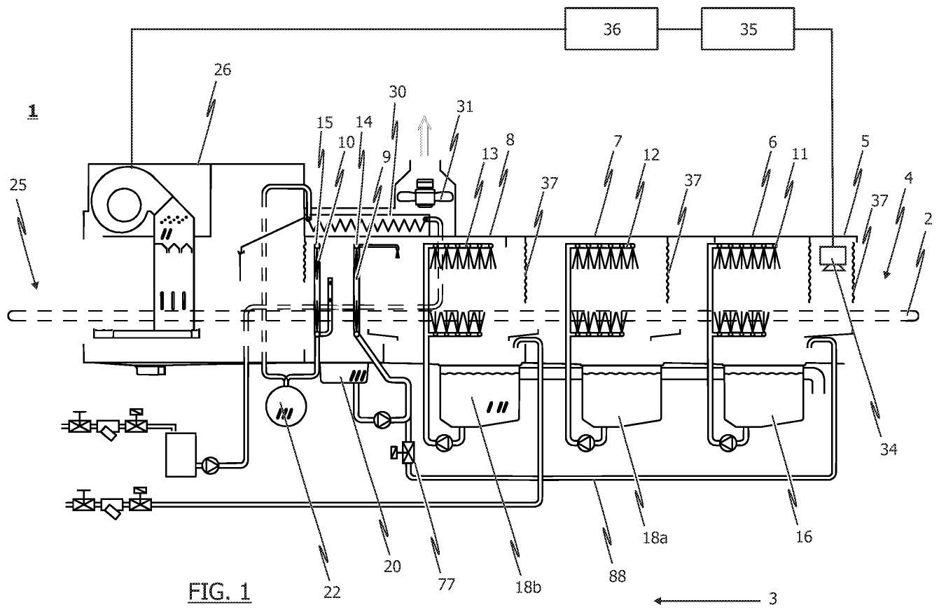

FIG. 1 shows a conveyor dishwasher 1 with a conveyor apparatus 2 for conveying washware not shown in the drawings through the conveyor dishwasher 1 in a direction of conveyance 3.

The conveyor apparatus 2 can be, for example, a conveyor belt, which is preferably configured as a multi-member plastic conveyor belt and is continuously driven by an electric drive not shown in FIG. 1, so that the washware placed upon the conveyor belt 2 is conveyed through the various treatment zones 6, 7, 8, 9, 10, and 26 of the conveyor dishwasher 1 according to the illustration in FIG. 1.

Typically, the washware conveyed in the direction of conveyance 3 is placed upon the conveyor apparatus or conveyor belt 2 in the region of the inlet 4. According to the direction of conveyance 3 indicated by the arrow, the washware is then conveyed from the inlet 4 into an inlet tunnel 5.

The conveyor dishwasher 1 according to the first embodiment of the present invention has at least one washing zone, for example as shown in FIG. 1, a pre-washing zone 6, as well as a first main washing zone 7 and a second main washing zone 8, which are arranged downstream of the pre-washing zone 6 when viewed in the direction of conveyance 3.

In the conveyor dishwasher 1 shown in FIG. 1, a post-washing zone 9 and a rinsing zone 10 downstream of the post-washing zone 9 are arranged downstream of the at least one washing zone 6, 7, 8 when viewed in the direction of conveyance 3.

In the illustration according to FIG. 1, the conveyor apparatus 2 is shown as a circumferential conveyor belt. However, conveyor racks in which the not explicitly shown washware is inserted and which are placed on the top of the conveyor belt are also conceivable as the conveyor apparatus 2.

When viewed in the direction of conveyance 3, the washware received either directly on the conveyor belt 2 or held by racks runs in the direction of conveyance 3 through the inlet tunnel 5, the subsequent pre-washing zone 6, the first main washing zone 7, the second main washing zone 8, the post-washing zone 9, the rinsing zone 10, a drying zone 26, and into an outlet path 25.

Spraying nozzles 11, 12, 13, 14, and 15 are respectively associated with the aforementioned treatment zones 6, 7, 8, 9, and 10 of the conveyor dishwasher 1, via which nozzles liquid is sprayed onto the washware conveyed by the conveyor apparatus 2 through the respective treatment zones 6, 7, 8, 9, and 10. Each treatment zone 6, 7, 8, 9, and 10 is associated with a tank 16, 18, 20, and 22 in which sprayed liquid is received and/or in which liquid is provided for the spraying nozzles of the respective zones. In the conveyor dishwasher 1 shown in FIG. 1, rinsing liquid is sprayed onto the washware, not shown in the illustrations, in the form of fresh water, which can be pure or mixed with further additives such as rinsing agents, via the spraying nozzles 15 of the rinsing zone 10 arranged above and below or to the side of the conveyor belt.

A portion of the sprayed rinsing liquid is conveyed from zone to zone in a cascading system counter to the direction of conveyance 3 of the washware. The remaining portion is guided directly into the pre-wash tank 16 via a valve 77 and a bypass line 88.

The sprayed rinsing liquid is collected in the tank 20 (post-wash tank 20) of the post-washing zone 9, from which it is conveyed via a pump system to the spraying nozzles 14 (post-washing nozzles 14) of the post-washing zone 9. In the post-washing zone 9, washing liquid is rinsed from the washware. The liquid resulting from this flows into the wash tank 18b of the second main washing zone 8, is usually provided with a cleaning agent and then sprayed onto the washware by a pumping system via the nozzles 13 (washing nozzles 13) of the second main washing zone 8.

Liquid flows from the wash tank 18b of the second main washing zone 8 into the wash tank 18a of the first main washing zone 7. From there, the liquid is again sprayed onto the washware by a further pump system via the washing nozzles 12 of the first main washing zone 7. From the wash tank 18a of the first main washing zone 7, the liquid then flows into the pre-wash tank 16 of the pre-washing zone 6. Liquid in the pre-wash tank 16 is sprayed onto the washware by a pumping system via the pre-washing nozzles 11 of the pre-washing zone 6 in order to remove coarse impurities from the washware.

The individual rinsing systems of the treatment zones 6, 7, 8, 9, and 10 ensure that the washware is sprayed from both the top and the bottom.

The respective zones 6, 7, 8, 9, and 10 of the conveyor dishwasher 1 can be separated from one another via separating curtains 37. In the embodiment shown in FIG. 1, the inlet tunnel 5 itself is also separated from the inlet 4 via a separating curtain 37. The provision of separating curtains 37 can prevent washing liquid and rinsing liquid from splashing out and vapor from escaping from the conveyor dishwasher.

The aforementioned drying zone 26 follows the rinsing zone 10 in the direction of conveyance 3 of the washware. In the drying zone 26, the washware is dried with dry and heated air in order to blow off or dry the moisture that is present on the washware. In order to maintain the moisture content of the air within a range that is favorable for drying, it is conceivable, for example, to supply room air via an opening, for example through the exit opening for the washware. The warm and moistened air is extracted from the drying zone 26, for example, by means of a fan 31 via a further opening.

It is advantageous for the exhaust air from the drying zone 26 to pass through a device for heat recovery 30, in which a condenser can be provided. The heat recovery device 30 serves to recover at least a portion of the heat energy contained in the exhaust air.

In today's belt/rack conveyor dishwashers, the washware is conveyed through multiple treatment zones, such as pre-washing zones, main washing zones, post-washing zones, rinsing zones, and drying zones.

As already indicated, different types of washware in the treatment zones of the conveyor dishwasher require different treatment parameters. However, with the currently known conveyor dishwashers, there is no automatic differentiation of the types of washware to be treated, so that conventional systems are typically designed as a compromise, such that they are more or less efficient for multiple types of washware. This approach leads to the fact that significantly more resources (energy, water, chemicals, etc.) are generally used in order to treat the washware than would actually be necessary.

The conveyor dishwasher 1 according to the invention, as shown for example in FIG. 1, is characterized in that the conveyor dishwasher 1 has a camera system 34, which is arranged above the conveyor apparatus 2 and is configured so as to take at least one image of an region of the conveyor apparatus 2, preferably continuously or at predetermined or determinable times and/or events.

The camera system 34 is associated with an image processing device 35, which is configured so as to, in particular, optionally pre-process the at least one image captured by the camera system 34, to segment the particularly optionally pre-processed image, to extract features, and to classify objects contained in the image (washware).

In the exemplary embodiment as shown in FIG. 1, the camera system with its associated image processing device serves in particular to detect a load of the conveyor apparatus with washware of at least one of the following washware categories:
cutlery or pieces of cutlery;
pots, pans, or GN containers;
glasses, in particular drinking glasses;
trays or tray-like objects;
plates, cups, or bowls;
utensils;
other washware;
mixed washware; and/or
plastic washware.

According to one embodiment of the conveyor dishwasher 1 as shown schematically in FIG. 1, it is provided that the control device 36, which is connected with signal or data technology to the camera system or the image processing device that is associated with the camera system, is designed so as to determine, in particular during a learning or observation phase, over at least one observation period and preferably over multiple observation periods, a temporal development of the load of the conveyor apparatus with certain washware categories. The observation period mentioned above is, for example, a washing shift, washing day, or washing week of the conveyor dishwasher, or a time period thereof.

Preferably, the control device is furthermore designed so as to “artificially” generate knowledge from the temporal development of the load of the conveyor apparatus with at least one of the aforementioned washware categories as captured in the learning or observation phase. The control device learns from examples during the learning or observation phase, and can generalize them after the learning phase has been completed. To this end, algorithms of the control device in machine learning can build a statistical model based on training data, which is tested against the test data.

The control device of the conveyor dishwasher is, in particular, designed so as to derive a pattern or regularity based on the determined temporal development of the load of the conveyor apparatus with at least one of the aforementioned washware categories.

The control device is further configured so as to identify time periods during at least one washing day, during at least one washing shift, or during at least one washing week of the dishwasher in which at least one specific washware category must at least predominately be treated by the conveyor dishwasher, based on a user-specific usage of the dishwasher over a predetermined or determinable period of time, which corresponds in particular to the learning or observation phase. For these time periods, corresponding treatment parameters adapted to the at least one specific washware category are then set using the control device.

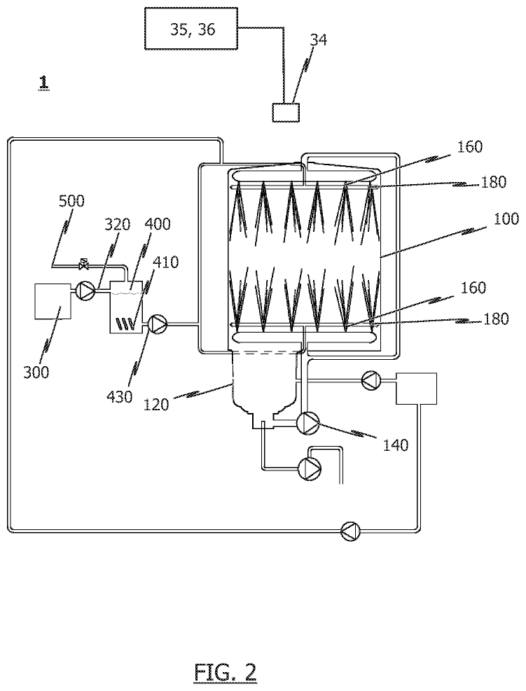

In FIG. 2, a further exemplary embodiment of the dishwasher 1 according to the invention is shown. This is a tableware dishwasher configured as a box-type dishwasher. It should be noted that this comprises only the components required for understanding the invention.

The dishwasher 1 shown in FIG. 2 comprises a treatment chamber 100 with an associated wash tank 120. The wash tank 120 serves to receive a treatment liquid, which can be conveyed to a plurality of washing nozzles 160 via a washing pump 140. In particular, according to the illustrated embodiment, the washing nozzles 160 are located in the upper and lower regions of the treatment chamber 100. They are connected to the wash tank 120 via a washing line 150. Because the wash tank 120 is located in the lower region of the treatment chamber 100, this can result in a recirculation of the treatment liquid after the spraying of the washware.

The shown dishwasher 1 further comprises at least one rinsing system for providing a rinsing liquid. In the illustrated embodiment, the rinsing system consists of a reservoir 300 that contains a rinsing concentrate. As can be seen in FIG. 2, the reservoir 300 of the rinsing system is connected to a water heater 400 via a liquid line 320. The water heater 400 comprises a fresh water port 500 through which fresh water (e.g. tap water) can be introduced into the water heater 400. The fresh water located in the water heater 400 is heated by a heating device 410 and mixed with the rinsing concentrate of the reservoir 300. For this purpose, the rinsing concentrate is conveyed through a dosing pump 310 from the reservoir 300 to the water heater 400. The rinsing liquid resulting from a combination of fresh water and rinsing concentrate can be conveyed to a plurality of rinsing nozzles 180 via a rinsing pump 430 and the associated rinsing lines 440. Similar to the washing nozzles 160, the rinsing nozzles 180 are also located inside the treatment chamber 100 of the dishwasher 1.

A program control device 36, shown merely schematically in FIG. 2, serves to control at least one cleaning program and is configured with the controllable components of the dishwasher 1 so as to implement a cleaning procedure (cleaning cycle) having the following sequential steps (phases):
1. a washing phase in which washing liquid from the wash tank 120 is sprayed by means of the washing pump 140 through the washing conduit system 150 into the treatment chamber 100 and then can flow back from the treatment chamber 100 into the wash tank 120 due to gravity;
2. a fresh water rinsing phase in which heated or unheated fresh water, or fresh water with dosed rinsing agent, is sprayed into the treatment chamber 100 as a rinsing liquid by means of the rinsing pump 430 and then can flow from the treatment chamber 100 into the wash tank 120 due to gravity; and
3. (optional) a drying phase in which drying air is circulated within the treatment chamber 100.

The dishwasher 1 according to the invention, as shown, for example, in FIG. 2, is characterized, among other things, by the fact that a washware detector apparatus 34, which is only schematically indicated in the drawings, is provided, which is used in order to capture the type or category of the washware received in the treatment chamber 100. The washware detector apparatus 34 is preferably positioned within or outside the treatment chamber 100, such that either the washware received in the treatment chamber 100 or a basket inserted into the treatment chamber 100 falls within the detection range. The term “washware detector apparatus” as used herein is understood to mean any detection apparatus that is designed so as to directly or indirectly detect or determine the type of washware delivered.

As with the conveyor dishwasher shown in FIG. 1, the program control device 36 of box-type dishwasher 1 shown in FIG. 2 is configured so as to “artificially” generate knowledge from the temporal development of the loading of treatment chamber 100 with at least one of the aforementioned washware categories washware captured in the learning or observation phase. The control device 36 learns from examples captured during the learning or observation phase, and can generalize them after the learning phase has been completed. To this end, algorithms of the control device 36 in machine learning can build a statistical model based on training data, which is tested against the test data.

The control device 36 is in particular designed so as to derive a pattern or regularity based on the determined temporal development of the loading of the treatment chamber 100 with at least one of the aforementioned washware categories.

The control device 36 is further configured so as to identify time periods during at least one washing day, during at least one washing shift, or during at least one washing week of the dishwasher 1 in which at least one specific washware category must at least predominately be treated by the dishwasher 1, based on a user-specific usage of the dishwasher 1 over a predetermined or determinable period of time, which corresponds in particular to the learning or observation phase. For these time periods, corresponding treatment parameters adapted to the at least one specific washware category are then set using the control device 36.

1. A commercial dishwasher having at least one washing system for washing washware, with at least one rinsing system for rinsing the washed washware and optionally a drying system for optimal drying of the rinsed washware, wherein the dishwasher comprises a camera system, which is configured so as to capture images, continuously or at predefined or definable times and/or events, of the washware to be treated in the dishwasher or of the washware treated in the dishwasher,
characterized in that
an evaluation device is further provided, which is configured so as to create a pattern relating to the temporal usage behavior of the operator of the dishwasher,
wherein the dishwasher further comprises a control device, which is configured, during operation of the dishwasher in a washing shift, in a washing day, or in a washing week, to proactively and in particular predictively adjust and/or temporally vary, automatically, at least one treatment parameter, according to which the washware is to be treated during washing, rinsing, and/or optional drying, as a function of the created pattern.

2. The dishwasher according to claim 1,
wherein the evaluation device is further configured, as a function of the created pattern relating to the temporal usage behavior of the operator of the dishwasher, to generate statistics and/or a corresponding notification and to output the latter to the operator of the dishwasher and/or to the manufacturer of the dishwasher and/or its distributor, wherein the notification contains a recommendation for an operation of the dishwasher that is optimized, with respect to the cleaning efficiency and with respect to conserving resources, and/or wherein the recommendation is a recommendation to upgrade or retrofit the dishwasher with an optimized treatment program and/or a recommendation to use a chemical, adapted to the usage behavior of the operator of the dishwasher (1).

3. The dishwasher according to claim 2,
wherein the at least one treatment parameter, which is proactively and predictively adjusted and/or temporally variable as a function of the pattern created, is selected from the following group:
a temperature of a washing liquid that is sprayed onto the washware for washing the washware;
an amount of washing liquid sprayed onto the washware per unit of time during washing of the washware;
a nozzle pressure of the washing liquid sprayed onto the washware during washing of the washware;
a cleaning agent concentration of the washing liquid sprayed onto the washware during washing of the washware;
a duration of a washing operation;
a temperature of a rinsing liquid that is sprayed onto the washware for rinsing the washware;
an amount of rinsing liquid sprayed onto the washware per unit time during rinsing of the washware;
a nozzle pressure of the rinsing liquid sprayed onto the washware during rinsing of the washware;
a rinsing aid concentration of the rinsing liquid sprayed onto the washware during rinsing of the washware;
a duration of a rinsing operation;
a temperature of a drying air that is blown onto the washware for optionally drying the washware;
an amount of drying air blown onto the washware per unit time during optional drying of the washware;
a pressure at which drying air is blown onto the washware during optional drying of the washware; and/or
a duration of an optional drying operation.

4. The dishwasher according to claim 1,
wherein, for creating the overall picture relating to the temporal usage behavior of the operator of the dishwasher, the evaluation device is configured so as to do the following, during a learning or observation phase over at least one observation period relating to a washing shift of the dishwasher, a washing day of the dishwasher, a washing week of the dishwasher, or a portion thereof,
determine a development over time of an average load level of the dishwasher (1) with the washware; and/or
determine a development over time of an average loading of the dishwasher (1) with washware having at least one predefined or definable washware category; and/or
determine a development over time of an average degree of soiling of the washware to be treated in the dishwasher (1); and/or
determine a development over time of an average type of soiling of the washware to be treated in the dishwasher,
and, based on the determined development over time of the average load level of the dishwasher with washware, based on the development over time of the average loading of the dishwasher with washware having the at least one predefined or definable washware category, based on the determined development over time of the average degree of soiling of the washware to be treated in the dishwasher, and/or based on the determined development over time of the average type of soiling of the washware to be treated in the dishwasher, to derive a pattern or regularity, wherein the learning or observation phase can initiated manually.

5. The dishwasher according to claim 4,
wherein the evaluation device is configured so as to evaluate the images captured by the camera system and determine whether at least one of the following washware categories was present at the time of the corresponding image capture:
cutlery or pieces of cutlery;
pots, pans, or GN containers;
glasses;
trays or tray-like objects;
plates, cups, or bowls;
utensils;
other washware;
mixed washware; and/or
plastic washware.

6. The dishwasher according to claim 4, wherein the evaluation device is configured in order to determine, during the learning or observation phase over the at least one observation period, a development over time of a average degree of soiling of the washware existing in the image capture region of the camera system at the time of the corresponding image capture and/or a development over time of a average type of soiling of the washware existing in the image capture region of the camera system at the time of the corresponding image capture, wherein the dishwasher comprises a control device, which is configured in order to, proactively and predictively, preferably automatically as a function of the determined development over time of the average degree of soiling of the washware and/or as a function of the determined development over time of the average type of soiling of the washware, initiate at least one measure influencing the quality of a washing liquid to be sprayed by the washing system and/or proactively and predictively at least one measure influencing the cleaning power of the dishwasher.

7. The dishwasher according to claim 6,
wherein the control device is configured in order to proactively and predictively set a volumetric flow rate and/or a nozzle pressure and/or a temperature of the washing liquid to be sprayed by the washing system for setting or adjusting the cleaning performance of the dishwasher as a function of the determined development over time of the average degree of soiling of the washware and/or as a function of the determined development over time of the average type of soiling of the washware; and/or
wherein the control device is configured in order to proactively and predictively set a cleaning agent concentration of the washing liquid to be sprayed by the washing system for setting or adjusting the cleaning performance of the dishwasher (1) as a function of the determined development over time of the average degree of soiling of the washware and/or as a function of the determined development over time of the average type of soiling of the washware; and/or
wherein the control device is configured in order to proactively and predictively set a duration of a washing operation and/or a duration of a rinsing operation for setting or adjusting the cleaning performance of the dishwasher as a function of the determined development over time of the average degree of soiling of the washware and/or as a function of the determined development over time of the average type of soiling of the washware; and/or
wherein the control device is configured in order to proactively and predictively set a quantity of fresh rinsewater introduced by the rinsing system for setting or adjusting the cleaning performance of the dishwasher as a function of the determined development over time of the average degree of soiling of the washware and/or as a function of the determined development over time of the average type of soiling of the washware; and/or
wherein the control device is configured in order to proactively and predictively set a separate wash tank regeneration quantity for setting or adjusting the cleaning performance of the dishwasher as a function of the determined development over time of the average degree of soiling of the washware and/or as a function of the determined development over time of the average type of soiling of the washware; and/or
wherein the control device is configured in order to proactively and predictively set and/or activate a separate and additional machine device, comprising a cleaning agent direct spraying system, for setting or adjusting the cleaning performance of the dishwasher as a function of the determined development over time of the average degree of soiling of the washware and/or as a function of the determined development over time of the average degree of soiling of the washware; and/or
wherein the control device is configured in order to proactively and predictively activate an additional pre-clearing or washing module for treating strongly soiled washware for setting or adjusting the cleaning performance of the dishwasher as a function of the determined development over time of the average degree of soiling of the washware and/or as a function of the determined development over time of the average degree of soiling of the washware.

8. The dishwasher according to claim 6,
wherein the control device is configured, automatically, as a function of the determined development over time of the average degree of soiling of the washware and/or as a function of a determined development over time of the average type of soiling of the washware, to proactively and predictively regenerate the washing liquid to be sprayed by the at least one washing system, namely by setting, proactively and predictively, in a controlling manner, a regeneration water quantity to be added per unit of time to the washing liquid to be sprayed, as a function of a determined development over time of the average degree of soiling of the washware and/or as a function of the determined development over time of the average type of soiling of the washware.

9. The dishwasher according to claim 8,
wherein the control device is configured, automatically, as a function of the determined development over time of the average degree of soiling of the washware and/or as a function of the determined development over time of the average type of soiling of the washware, to proactively and predictively set the soil-carrying capacity of the washing liquid to be sprayed by the at least one washing system, or to at least adjust it to the determined development over time of the average degree of soiling and/or the determined development over time of the average type of soiling of the washware.

10. The dishwasher according to claim 9,
wherein the control device is configured for setting or adjusting the soil-carrying capacity of the washing liquid to be sprayed by the at least one washing system to proactively and predictively set, in a controlling manner, a temperature of the washing liquid and/or a cleaning agent concentration of the washing liquid.

11. The dishwasher according to claim 10,
wherein the control device is further configured so as to divide the treatment period, which relates to a washing shift, a washing day, or a washing week of the dishwasher, or a period thereof, into a first sub-period and into at least one further second sub-period, wherein:
in the first sub-period of the observation period, a determined average load level of the dishwasher with washware corresponds to a first relative value or falls within a first relative value range, wherein, in the at least one second sub-period of the observation period, the determined average load level of the dishwasher with washware corresponds to a second relative value or falls within a second relative value range, wherein the first relative value of the average load level of the dishwasher with washware corresponds to a loading of the dishwasher with washware which is preferably larger than the loading of the dishwasher (1) with washware corresponding to the second relative value of the average load level of the dishwasher (1) with washware; and/or
in the first sub-period of the observation period, a determined average load level of the dishwasher with at least one predefined or definable washware category corresponds to a first relative value or falls within a first relative value range, wherein, in the at least one second sub-period of the observation period, the determined average load level of the dishwasher with at least one predefined or definable washware category corresponds to a second relative value or falls within a second relative value range, wherein the first relative value of the average load level of the dishwasher with the at least one washware category corresponds to a loading of the dishwasher with the at least one washware category which is preferably larger than the loading of the dishwasher with the at least one washware category corresponding to the second relative value of the average load level of the dishwasher with the at least one washware category; and/or
in the first sub-period of the observation period, a determined average degree of soiling of the washware to be treated in the dishwasher corresponds to a first relative value or falls within a first relative value range, wherein, in the at least one second sub-period of the observation period, the determined average degree of soiling of the washware to be treated in the dishwasher corresponds to a second relative value or falls within a second relative value range, wherein the first relative value of the average degree of soiling of the washware corresponds to a soil input into the dishwasher which is preferably larger than the soil input into the dishwasher corresponding to the second relative value of the average degree of soiling of the washware; and/or
in the first sub-period of the observation period, a determined average type of soiling of the washware to be treated in the dishwasher corresponds to a first relative value or falls within a first relative value range, wherein, in the at least one second sub-period of the observation period, the determined average type of soiling of the washware to be treated in the dishwasher corresponds to a second relative value or falls within a second relative value range, wherein the first relative value of the average type of soiling of the washware corresponds to a type of soiling of the washware which is different than the type of soiling of the washware corresponding to the second relative value of the average type of soiling of the washware.

12. The dishwasher according to claim 11,
wherein the control device is further configured, after the end of the learning or observation phase, during the operation of the dishwasher in a washing shift, in a washing day, or in a washing week for the first sub-period, to proactively select and predictively set accordingly, at least one first predefined treatment parameter, according to which the washware is to be treated during washing, rinsing, and/or optional drying during the first sub-period, and for the at least one second sub-period, to proactively select and predictively set accordingly at least one second predefined treatment parameter, according to which the washware is to be treated during washing, rinsing, and/or optional drying during the at least second sub-period.

13. The dishwasher according to claim 11,
wherein the first sub-period is at least a first time slot of a washing day, a washing shift, or a washing week of the dishwasher, and wherein the second sub-period is at least a time slot different from the first time slot of a washing day, a washing shift, or a washing week of the dishwasher; or
wherein the first sub-period is at least a first day of the week, and wherein the second sub-period is at least a second day of the week that is different from the first day of the week.

14. The dishwasher according to claim 1,
wherein the evaluation device is configured to determine an operator-specific usage of the dishwasher, over a predefined or definable period of time, corresponding to a learning or observation phase, and wherein the evaluation device is further configured to do the following, based on the determined operator-specific usage of the dishwasher, over the predefined or definable period of time:
determine at least one first period of time during at least one washing day, washing shift, or washing week of the dishwasher, in which only a relatively small number of washware pieces are to be treated by the dishwasher per unit of time, and at least one second period of time during at least one washing day, washing shift, or washing week of the dishwasher, in which a relatively high number of washware pieces are to be treated by the dishwasher per unit of time, and, for these time periods, proactively and predictively, set treatment parameters adapted to the number of washware pieces to be treated per unit of time; and/or
determine time periods during at least one washing day, washing shift, or washing week of the dishwasher, in which at least one particular category of washware is to be treated by the dishwasher at least predominantly, and, for these time periods, proactively and predictively, set treatment parameters adapted to the at least one determined washware category; and/or
determine time periods during at least one washing day, washing shift, or washing week of the dishwasher, in which at least predominantly strongly soiled washware is to be treated by the dishwasher, and, for these time periods, proactively and predictively, set treatment parameters adapted to the degree of soiling and/or the type of soiling; and/or
determine time periods during at least one washing day, washing shift, or washing week of the dishwasher, in which at least predominantly lightly soiled washware is to be treated by the dishwasher, and, for these time periods, proactively and predictively, set treatment parameters adapted to the degree of soiling and/or the type of soiling.

15. A method for operating a commercial dishwasher for cleaning washware, wherein the dishwasher comprises at least one washing system for washing the washware to be treated, at least one rinsing system for rinsing the washed washware, and optionally at least one drying system for optionally drying the rinsed washware, and wherein the method comprises the following method steps:
with the aid of a camera system, images of the washware to be treated in the dishwasher or of the washware treated in the dishwasher are taken continuously or at predefined or definable times and/or events;
a pattern relating to the temporal usage behavior of the operator of the dishwasher is created, in the course of a profiling process based on the captured images; and
during operation of the dishwasher in a washing shift, in a washing day, or in a washing week, at least one treatment parameter, determined in advance, according to which the washware is to be treated during washing, rinsing, and/or optional drying is proactively and predictively set and/or temporally varied as a function of the created pattern.
